(19) United States
(12) Patent Application Publication
(10) Pub. No.: US 2025/0338894 A1
(43) Pub. Date: Nov. 6, 2025

(54) CAPSULES INCLUDING MULTIPLE INTERNAL COMPARTMENTS AND HEAT-NOT-BURN (HNB) AEROSOL-GENERATING DEVICES INCLUDING THE SAME

(71) Applicant: Altria Client Services LLC, Richmond, VA (US)

(72) Inventors: Zack W. BLACKMON, Williamsburg, VA (US); Eric HAWES, Midlothian, VA (US); Rangaraj S. SUNDAR, Midlothian, VA (US); Raymond W. LAU, Glen Allen, VA (US); Jarrett KEEN, Richmond, VA (US); Niall GALLAGHER, Cambridge (GB)

(73) Assignee: Altria Client Services LLC, Richmond, VA (US)

(21) Appl. No.: 19/199,793

(22) Filed: May 6, 2025

Related U.S. Application Data
(60) Provisional application No. 63/642,942, filed on May 6, 2024.

(51) Int. Cl. A24F 40/46; A24B 13/02; A24F 40/20; A24F 40/485; H05B 3/22

(52) U.S. Cl. CPC A24F 40/46; A24B 13/02; A24F 40/20; A24F 40/485; H05B 3/22

(57) ABSTRACT

A capsule for an aerosol-generating device may include a housing and a heating assembly within the housing. The housing defines a plurality of internal compartments, a plurality of inlet openings, and a plurality of outlet openings. Each of the plurality of internal compartments contains an aerosol-forming substrate. The heating assembly within the housing extends into each of the plurality of internal compartments. The heating assembly includes a plurality of heater sections and electrical contacts for the plurality of heater sections. A device body is configured to receive the capsule, and to supply an electric current to the plurality of heater sections of the heating assembly to sequentially heat the aerosol-forming substrate within the plurality of internal compartments of the capsule to generate an aerosol.

### CROSS-REFERENCE TO RELATED APPLICATION

This application claims priority under 35 U.S.C. § 119 to U.S. Provisional Application No. 63/642,942, filed on May 6, 2024, the entire contents of which are hereby incorporated herein by reference.

### BACKGROUND

### Field

The present disclosure relates to capsules and heat-not-burn (HNB) aerosol-generating devices including the same for generating an aerosol without involving a self-sustaining burning/combustion of the aerosol-forming substrate.

### Description of Related Art

Some electronic devices are configured to heat a plant material to a temperature that is sufficient to release constituents of the plant material while keeping the temperature below its ignition temperature so as to avoid a self-sustaining burning or a self-sustaining combustion of the plant material (i.e., in contrast to where a plant material is lit, such as lit-end cigarettes). Such devices may be characterized as generating an aerosol of constituents released by heating, and may be referred to as heat-not-burn aerosol-generating devices, or heat-not-burn devices. Heat-not-burn aerosol-generating devices may also be referred to as heated tobacco products (HTP) aerosol-generating devices.

### SUMMARY

At least one embodiment relates to a capsule for a heat-not-burn (HNB) aerosol-generating device. In an example embodiment, the capsule may include a housing defining a plurality of internal compartments, a plurality of inlet openings, and a plurality of outlet openings, each of the plurality of internal compartments containing an aerosol-forming substrate; and a heating assembly within the housing and extending into each of the plurality of internal compartments, the heating assembly including a plurality of heater sections and electrical contacts for the plurality of heater sections.

At least one embodiment relates to a heat-not-burn (HNB) aerosol-generating device. In an example embodiment, the aerosol-generating device may include a capsule defining a plurality of internal compartments containing an aerosol-forming substrate and including a heating assembly extending into each of the plurality of internal compartments; and a device body configured to receive the capsule and to supply an electric current to sections of the heating assembly so as to heat the aerosol-forming substrate within the plurality of internal compartments of the capsule to generate an aerosol.

At least one embodiment relates to a method of heating with a heat-not-burn (HNB) aerosol-generating device. In an example embodiment, the method may include receiving a capsule into a device body of the aerosol-generating device in a first orientation, the capsule defining a plurality of internal compartments containing an aerosol-forming substrate and including a heating assembly extending into each of the plurality of internal compartments; and supplying current to a first heater section of the heating assembly of the capsule to heat the aerosol-forming substrate located in a first one of the plurality of internal compartments of the capsule.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is an upper perspective view of a capsule for an aerosol-generating device according to an example embodiment.

FIG. 2 is a lower perspective view of the capsule of FIG. 1.

FIG. 3 is a cross-sectional view of the capsule of FIG. 1.

FIG. 4 is a cross-sectional view of the capsule of FIG. 1 in a first orientation within an aerosol-generating device.

FIG. 5 is a cross-sectional view of the capsule of FIG. 1 in a second orientation within the aerosol-generating device.

FIG. 6 is an exploded view of a capsule for an aerosol-generating device according to an example embodiment.

FIG. 7 is a partially exploded view of another capsule for an aerosol-generating device according to an example embodiment.

FIG. 8 is a partially exploded view of another capsule for an aerosol-generating device according to an example embodiment.

FIG. 9 is a flowchart depicting an example method of heating a capsule according to an example embodiment.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives thereof. Like numbers refer to like elements throughout the description of the figures.

It should be understood that when an element or layer is referred to as being “on,” “connected to,” “coupled to,” “attached to,” “adjacent to,” or “covering” another element or layer, it may be directly on, connected to, coupled to, attached to, adjacent to or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations or sub-combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements, and/or groups thereof.

When the terms “about” or “substantially” are used in this specification in connection with a numerical value, it is intended that the associated numerical value includes a manufacturing or operational tolerance (e.g., ±10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

The processing circuitry may be hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

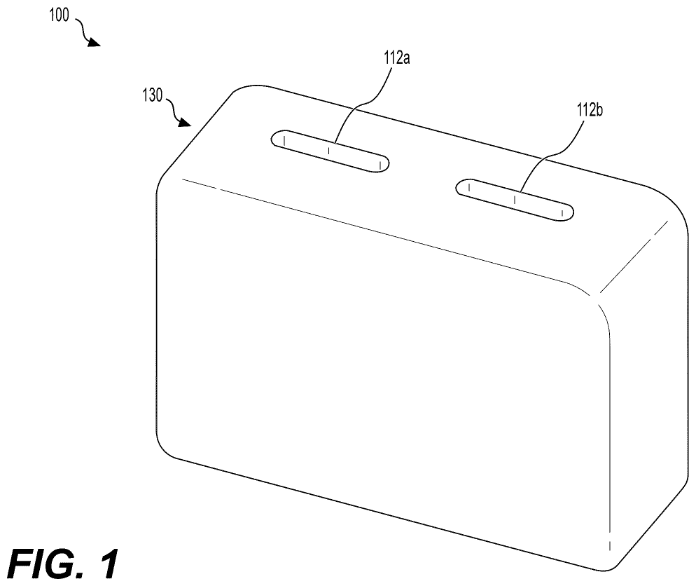

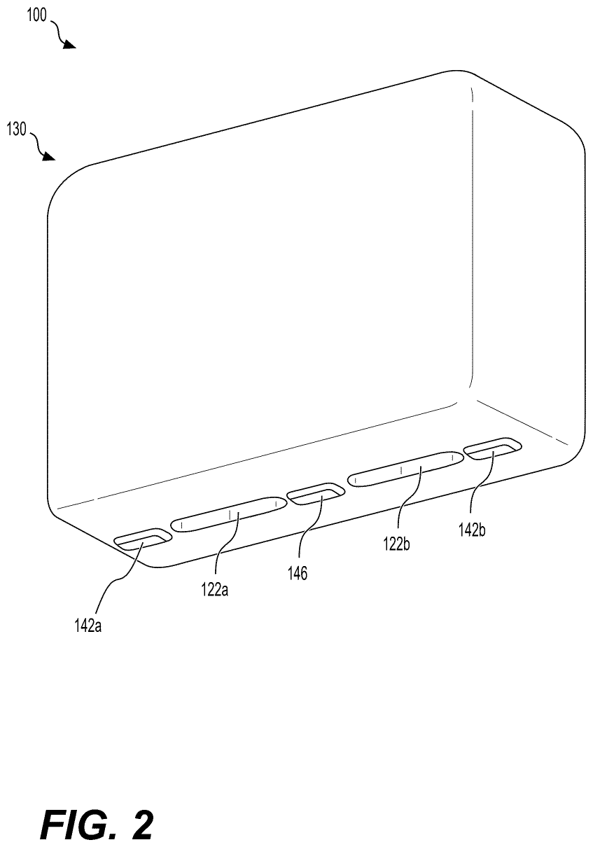

FIG. 1 is an upper perspective view of a capsule for an aerosol-generating device according to an example embodiment. FIG. 2 is a lower perspective view of the capsule of FIG. 1. Referring to FIGS. 1-2, a capsule 100 includes a housing 130 configured to contain an aerosol-forming substrate within a plurality of internal compartments. The housing 130 may have a form resembling a hollow polyhedron with external quadrilateral faces. For instance, the housing 130 may have a cuboid-like shape which includes a front face, a rear face opposite the front face, a first side face between the front face and the rear face, a second side face opposite the first side face, an upstream end face between the first side face and the second side face, and a downstream end face opposite the upstream end face. In an example embodiment, the downstream end face, the front face, and the second side face are visible in FIG. 1, while the upstream end face, the front face, and the second side face are visible in FIG. 2.

Although the capsule 100 is illustrated as having a cuboid-like shape (e.g., rounded rectangular cuboid) with a rectangular cross-section, it should be understood that example embodiments are not limited thereto. For instance, in some embodiments, the capsule 100 may have a shape wherein a cross-section (e.g., vertical and/or horizontal cross-section) resembles a rectangle with a pair of opposing semicircular ends (e.g., elongated circle, obround, discorectangle, stadium, racetrack), an oval/ovoid, or an ellipse. Alternatively, the shape may be circular such that the capsule 100 has a disk-like appearance. In other instances, the capsule 100 may have a polygonal shape (regular or irregular), including a triangle, a rectangle (e.g., square), a pentagon, a hexagon, a heptagon, or an octagon. The capsule 100 may include a laminar structure and generally planar form to facilitate stacking, so as to allow a plurality of capsules to be stored in an aerosol-generating device or other receptacle for dispensing a new capsule or receiving a depleted capsule.

As will be discussed herein in more detail, the capsule 100 is configured to be received within an aerosol-generating device (e.g., a heat-not-burn aerosol-generating device) which, when operated, will generate an aerosol that is entrained with an airflow that is drawn into and through the aerosol-generating device and the capsule 100. As shown in the drawings, the housing 130 of the capsule 100 defines a plurality of inlets for the airflow and a plurality of outlets for the aerosol. In an example embodiment, the downstream end face of the housing 130 in FIG. 1 defines outlets in the form of a first outlet opening 112a and a second outlet opening 112b (e.g., a plurality of outlet openings). Conversely, the upstream end face of the housing 130 in FIG. 2 defines inlets in the form of a first inlet opening 122a and a second inlet opening 122b (e.g., a plurality of inlet openings). Furthermore, when received within an aerosol-generating device, power may be supplied to the capsule 100 via a first outer electrical contact 142a, an inner electrical contact 146, and a second outer electrical contact 142b (e.g., a plurality of electrical contacts), which will be subsequently discussed herein in more detail.

Although the first outlet opening 112a, the second outlet opening 112b, the first inlet opening 122a, and the second inlet opening 122b are illustrated as elongated apertures (e.g., slots), it should be understood that example embodiments are not limited thereto. For instance, instead of each of the first outlet opening 112a, the second outlet opening 112b, the first inlet opening 122a, and the second inlet opening 122b being a single elongated aperture, one or more of the first outlet opening 112a, the second outlet opening 112b, the first inlet opening 122a, and the second inlet opening 122b may instead be in the form of a plurality of apertures. For example, one or more of the first outlet opening 112a, the second outlet opening 112b, the first inlet opening 122a, and the second inlet opening 122b may include a series of linearly arranged apertures, multiple apertures arranged in an array of rows and columns, multiple apertures that are not aligned with one another, and so on. Each of the first outlet opening 112a, the second outlet opening 112b, the first inlet opening 122a, and the second inlet opening 122b may have more or less apertures than other openings, and may have apertures that are arranged differently than other openings. In some example embodiments, one or more of the first outlet opening 112a, the second outlet opening 112b, the first inlet opening 122a, and the second inlet opening 122b may define a different shape than an elongated aperture slot, such as a circular hole, a square or rectangular opening, longer or shorter openings, wider or narrower openings, etc.

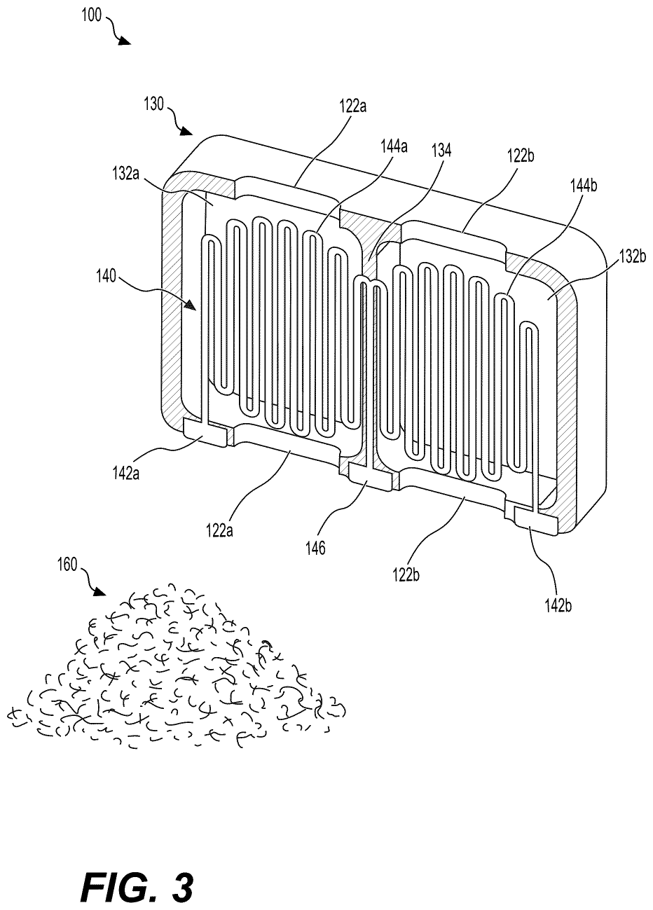

FIG. 3 is a cross-sectional view of the capsule 100 of FIG. 1. As shown in FIG. 3, the housing 130 defines a first internal compartment 132a and a second internal compartment 132b. Although the first internal compartment 132a and the second internal compartment 132b are illustrated as rectangular cubic volumes each including a front wall, a back wall, and four side walls between the front wall and back wall, example embodiments are not limited thereto. For example, other example embodiments may include internal compartments that are square-shaped, hexagonal, trapezoidal, etc., may have sloped walls, may have side wall corners that are not rounded (such as right-angle corners or slanted wall corners), and so on. Although FIG. 3 illustrates the first internal compartment 132a and the second internal compartment 132b having the same shape and size, other example embodiments may include internal compartments having different shapes than one another and/or different sizes than one another. In some example embodiments, the housing 130 may include more than two internal compartments (e.g., three or more internal compartments).

The first internal compartment 132a and the second internal compartment 132b may be separated (e.g., isolated) from one another. As shown in FIG. 3, the housing 130 includes a partition wall 134 that separates the first internal compartment 132a from the second internal compartment 132b. The partition wall 134 may be integral with other portions of the housing 130, or may be a separate wall portion that is connected to other portions of the housing 130. The partition wall 134 may have any suitable size, thickness, etc. to separate the first internal compartment 132a from the second internal compartment 132b, and other example embodiments may have more than one partition wall.

The housing 130 may be formed of a metal/alloy, a high-temperature plastic, and/or a plant material. In some instances, the metal may include aluminum, and the alloy may be stainless steel. Materials for the housing 130 and the partition wall 134 may be selected to reduce or minimize heat flow from the first internal compartment 132a to the second internal compartment 132b (e.g., to reduce or minimize unintended heating of the second internal compartment 132b while the first internal compartment 132a is being operated. For example, insulating materials such as pulp, paper, plant material, high temperature plastic, etc., may be used to reduce or minimize heat flow. Non-limiting examples of suitable high-temperature plastics include liquid crystal polymer (LCP), polyetheretherketone (PEEK), or cyclic olefin copolymer (COC). The plant material may include cellulose fibers (e.g., in the form of paper pulp). As for dimensions, the housing may have a thickness (e.g., wall thickness) of about 0.4 mm-0.6 mm (e.g., 0.5 mm), although example embodiments are not limited thereto. In addition to being wholly formed of one of the above materials, the housing 130 may also have a composite/multi-layer structure. For instance, the housing 130 may include an underlying/inner layer of metal combined with an overlying/outer layer of plastic and/or plant material (e.g., paper, cardboard).

When a metal/alloy is used to produce the housing 130, the fabrication process may include pressing/drawing (e.g., punching an appropriate shape out of a sheet of the metal/alloy) and cutting to form the housing 130. In another instance, the fabrication process may include stamping a sheet of the metal/alloy to an appropriate size/shape and folding the sheet to form the housing 130, followed by an optional seam welding/joining and/or application of a label. These processes may reduce fabrication costs. In yet another instance, the fabrication process may include extrusion of the metal/alloy to form the housing 130.

As shown in FIG. 3, the first internal compartment 132a is located between the first inlet opening 122a and the first outlet opening 112a. The second internal compartment 132b is located between the second inlet opening 122b and the second outlet opening 112b. Therefore, each of the plurality of internal compartments is between at least one of the plurality of inlet openings and at least one of the plurality of outlet openings.

The first inlet opening 122a and the first outlet opening 112a are configured to provide air flow through the first internal compartment 132a. The second inlet opening 122b and the second outlet opening 112b are configured to provide air flow through the second internal compartment 132b. The air flow through the first internal compartment 132a may be independent of the air flow through the second internal compartment 132b (e.g., due to the partition wall 134). Therefore, the first inlet opening 122a, the second inlet opening 122b, the first outlet opening 112a and the second outlet opening 112b are configured to provide an independent air flow through each of the first internal compartment 132a and the second internal compartment 132b.

As shown in FIG. 3, the capsule 100 includes a heating assembly 140. The heating assembly 140 is embedded within the housing 130. For example, during manufacturing, the heating assembly 140 may be embedded within the housing 130 via injection molding (e.g., insert molding, overmolding). The heating assembly 140 includes a first heater section 144a and a second heater section 144b. The first heater section 144a is located inside the first internal compartment 132a, and the second heater section 144b is located inside the second internal compartment 132b. Therefore, each of the plurality of heater sections is located within one of the plurality of internal compartments.

As described above, the housing 130 includes the partition wall 134 configured to separate adjacent internal compartments (e.g., the partition wall 134 separates the first internal compartment 132a from the adjacent second internal compartment 132b). As shown in FIG. 3, the heating assembly 140 extends through the partition wall 134. In particular, the first heater section 144a is on one side of the partition wall 134, and the second heater section 144b is on the opposite side of the partition wall 134. As shown in FIG. 3, the first heater section 144a is aligned between the first inlet opening 122a and the first outlet opening 112a, and the second heater section 144b is aligned between the second inlet opening 122b and the second outlet opening 112b.

Although FIG. 3 illustrates the first heater section 144a as being coplanar with the second heater section 144b, other example embodiments may include heater sections having different sizes, different shapes, different arrangements or configurations, etc. For example, the first heater section 144a may have a different size than the second heater section 144b, and may have a different shape than the second heater section 144b. The first heater section 144a and the second heater section 144b may each have a planar and winding form resembling a compressed oscillation or zigzag with a plurality of parallel segments (e.g., six to sixteen parallel segments). Each parallel segment may have a width of about 0.28 mm-0.32 mm (e.g., 0.30 mm) and a spacing between parallel segments of about 0.30 mm-0.34 mm (e.g., 0.32 mm), although other dimensions are also possible. In an example embodiment, the first heater section 144a and the second heater section 144b may each occupy a rectangular area so as to more fully heat the first internal compartment 132a and the second internal compartment 132b. However, it should be understood that other forms for the first heater section 144a and the second heater section 144b are also possible (e.g., circular form, oval form, spiral form, flower-like form). Additionally, the first outer electrical contact 142a, the second outer electrical contact 142b, and the inner electrical contact 146 may be oriented parallel to the plane of the first heater section 144a and the second heater section 144b, or orthogonally to the plane of the first heater section 144a and the second heater section 144b.

In some example embodiments, a sheet material may be cut or otherwise processed (e.g., stamping, electrochemical etching, die cutting, laser cutting) to produce the heating assembly 140. In such an instance, the heating assembly 140 will have an integral, continuous form. The sheet material may be formed of one or more conductors configured to undergo Joule heating (which is also known as ohmic/resistive heating) upon the application of an electric current thereto. For example, the heating assembly may be formed of one or more conductors and configured to produce heat when an electric current passes therethrough. The electric current may be applied to electrical contacts of the heating assembly 140 (as described further below), from a power source (e.g., battery) within an aerosol-generating device. Suitable conductors for the sheet material include an iron-based alloy (e.g., stainless steel, iron aluminides), a nickel-based alloy (e.g., nichrome), and/or a ceramic (e.g., ceramic coated with metal). For instance, the stainless steel may be a type known in the art as SS316L, although example embodiments are not limited thereto. The sheet material may have a thickness of about 0.10 mm-0.30 mm (e.g., 0.15 mm-0.25 mm). The heating assembly 140 may have a resistance between 0.4 Ohm-2.5 Ohms (e.g., 0.4 Ohm-0.8 Ohm, 0.5 Ohm-0.7 Ohm, 1.0 Ohm-2.0 Ohms, etc.).

The heating assembly 140 includes a plurality of electrical contacts. In particular, the heating assembly 140 includes a first outer electrical contact 142a, a second outer electrical contact 142b, and an inner electrical contact 146. The first outer electrical contact 142a is located at an outer end (e.g., terminus) of the first heater section 144a adjacent the first internal compartment 132a, and the second outer electrical contact 142b is located at an outer end (e.g., terminus) of the second heater section 144b adjacent the second internal compartment 132b.

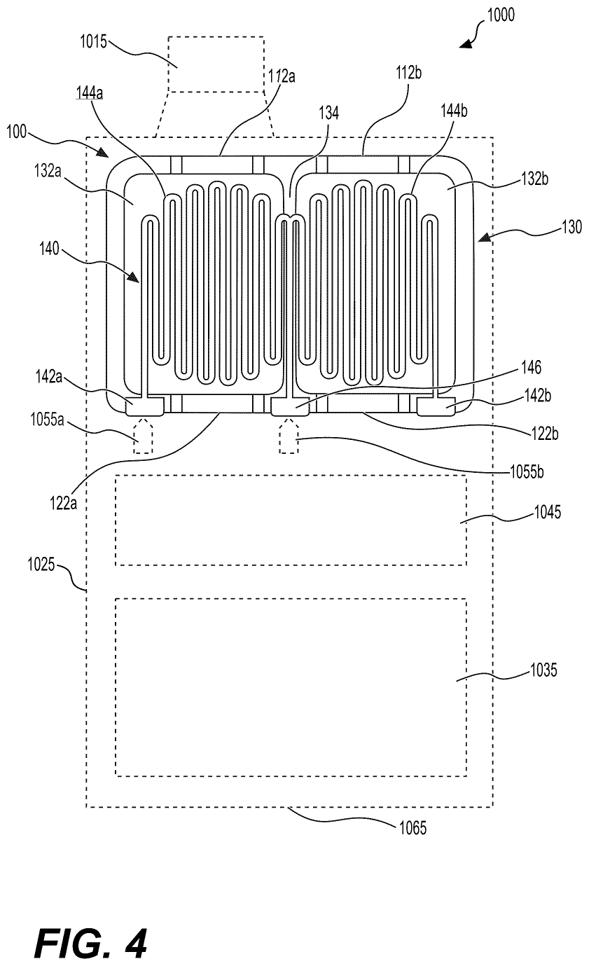

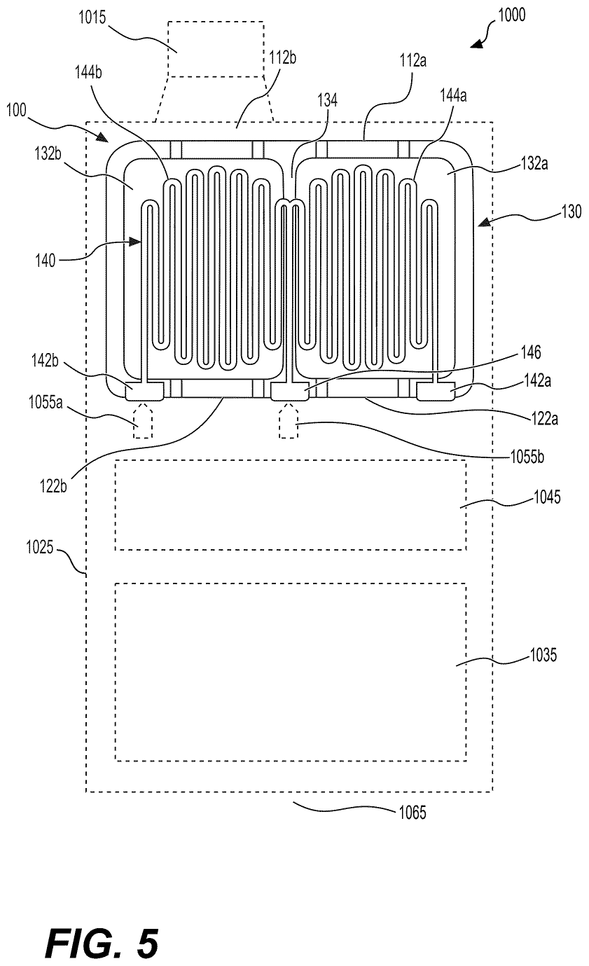

The inner electrical contact 146 is located between the first heater section 144a and the second heater section 144b. In the arrangement illustrated in FIG. 3, the first outer electrical contact 142a and the inner electrical contact 146 are configured to electrically connect the first heater section 144a to a power source, such as the power source 1035 of the aerosol-generating device 1000 illustrated in FIGS. 4 and 5 (e.g., for receiving an electric current from the power source 1035). Similarly, the second outer electrical contact 142b and the inner electrical contact 146 are configured to connect the second heater section 144b to the power source, such as the power source 1035 of the aerosol-generating device 1000 illustrated in FIGS. 4 and 5.

The electric current from the power source within the aerosol-generating device may be transmitted via electrodes configured to electrically contact the first outer electrical contact 142a, the second outer electrical contact 142b and/or the inner electrical contact 146 of the heating assembly 140 when the capsule 100 is inserted into the aerosol-generating device. In a non-limiting embodiment, the electrodes may be spring-loaded to enhance an engagement with the heating assembly 140 of the capsule 100. Also, the movement (e.g., engagement, release) of the electrodes may be achieved by mechanical actuation. Furthermore, the supply of the electric current from the aerosol-generating device to the capsule 100 may be a manual operation (e.g., button-activated) or an automatic operation (e.g., puff-activated).

Each of the first internal compartment 132a and the second internal compartment 132b may contain an aerosol forming substrate, such as the aerosol-forming substrate 160. Although FIG. 3 illustrates the aerosol-forming substrate 160 outside of the housing 130, it should be understood that in other embodiments where the capsule 100 is fully assembled, the aerosol-forming substrate 160 is located in each of the first internal compartment 132a and the second internal compartment 132b. Therefore, during the operation of an aerosol-generating device with the capsule 100 loaded therein, the first heater section 144a of the heating assembly 140 heats the aerosol-forming substrate 160 located in the first internal compartment 132a, and the second heater section 144b heats the aerosol-forming substrate 160 located in the second internal compartment 132b.

In some example embodiments, the first outer electrical contact 142a, the second outer electrical contact 142b, and the inner electrical contact 146 are configured to electrically connect to a power source when the capsule 100 is loaded into a device body of an aerosol-generating device, such as the device body 1025 of the aerosol-generating device 1000 of FIGS. 4 and 5. When the heating assembly 140 is activated (e.g., so as to undergo Joule heating), the temperature of the aerosol-forming substrate 160 may increase, and an aerosol may be generated and drawn or otherwise released through the first outlet opening 112a and/or the second outlet opening 112b, before continuing downstream and exiting from the mouthpiece (e.g., the mouthpiece 1015 of the aerosol-generating device 1000 of FIGS. 4-5).

The aerosol forming substrate may include any suitable material, including a plant material, as described further below. For example, the plant material may include tobacco, but example embodiments are not limited thereto. In some example embodiments, the aerosol-forming substrate 160 may be the same in the first internal compartment 132a and the second internal compartment 132b. In other example embodiments, the aerosol-forming substrate 160 in the first internal compartment 132a may be different than the aerosol-forming substrate 160 located in the second internal compartment 132b.

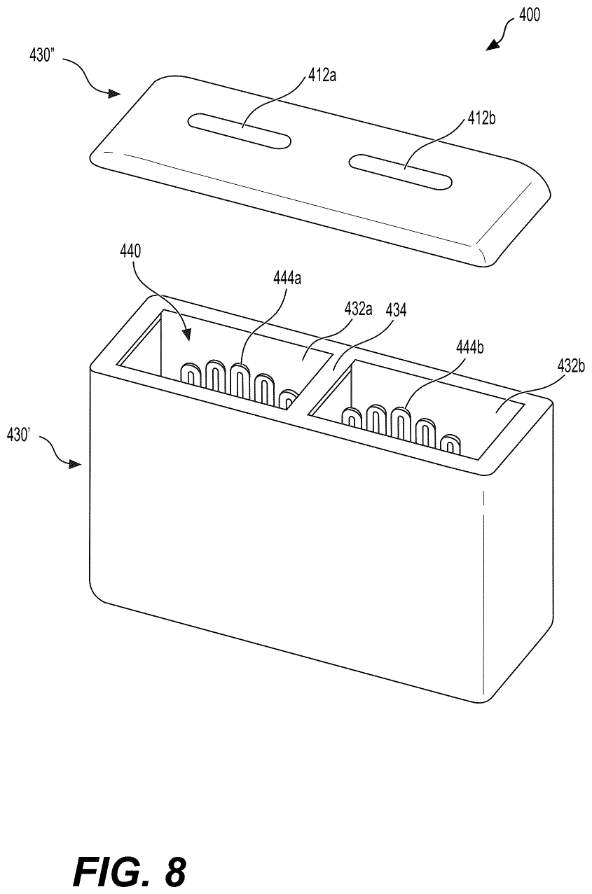

The aerosol-forming substrate 160 for the capsule 100 may be in a consolidated form or in a loose form. Specifically, when in a consolidated form, the aerosol-forming substrate 160 may have a shape that facilitates its placement within the housing 130. For instance, the aerosol-forming substrate 160 may be in the form of one or more rectangular sheets/slabs dimensioned for insertion into the first internal compartment 132a and the second internal compartment 132b. When in a loose form, the aerosol-forming substrate 160 may be loaded into the first internal compartment 132a and the second internal compartment 132b via a vacuum-assisted process. With such a process, the housing 130 may first be partially assembled. A vacuum may then be applied to one or more of the first inlet opening 122a, the second inlet opening 122b, the first outlet opening 112a, and the second outlet opening 112b to pull aerosol-forming substrate 160 provided in the vicinity into the first internal compartment 132a and/or the second internal compartment 132b. For example, when the housing 130 is structured to include a body section and an end cap section (e.g., FIG. 8) wherein the body section defines all or a majority of the first internal compartment 132a and the second internal compartment 132b, a vacuum may be applied to one or more of the first inlet opening 122a and the second inlet opening 122b in the body section to draw the aerosol-forming substrate 160 into the first internal compartment 132a and the second internal compartment 132b prior to securing the end cap section to the body section. The level of the vacuum may be varied as appropriate to achieve the desired density of the aerosol-forming substrate 160 for the capsule 100. In this manner, a plurality of capsules 100 may be loaded simultaneously and relatively consistently. Additionally, each of the openings of the housing 130 may have a width of about 0.26 mm-0.30 mm (e.g., 0.28 mm) to reduce or prevent the egress of particles of the aerosol-forming substrate 160.

In some example embodiments, the housing 130 may be composed of a capsule shell (as a body section), an upstream end cap, and a downstream end cap. The capsule shell may be formed as a single case, such as an aluminum case that is open at both ends. At a bottom end of the case, an upstream end cap (e.g., made of or otherwise including LCP) defining a first inlet opening 122a and a second inlet opening 122b and including a molded heater (e.g., heating assembly 140) may be inserted into the case and fixed. With the capsule 100 lined up in a vertical orientation, ground/loose plant material (or another form factor) as the aerosol-forming substrate 160 may be introduced into the capsule 100 in a controlled manner, and may be partially aided by a vacuum applied to the bottom/upstream end cap via the first inlet opening 122a and the second inlet opening 122b. Once the filling of the capsule 100 is completed, a top/downstream end cap (e.g., made of or otherwise including LCP) defining a first outlet opening 112a and a second outlet opening 112b may then be fitted to seal the capsule 100 so as to retain the aerosol-forming substrate 160 therein.

As discussed herein, the aerosol-forming substrate 160 is a material or combination of materials that may yield an aerosol. An aerosol relates to the matter generated or output by the devices disclosed, claimed, and equivalents thereof. The material may include a compound (e.g., nicotine, cannabinoid), wherein an aerosol including the compound is produced when the material is heated.

It is understood that heating of a plant material below its ignition temperature may, in some circumstances, produce incidental and insubstantial levels of oxidized or other thermal decomposition byproducts. However, in some embodiments, the heating in aerosol-generating devices is below the pyrolysis temperature of the plant material so as to produce an aerosol having no or insubstantial levels of thermal decomposition byproducts of the plant material. Thus, in an example embodiment, pyrolysis of the plant material does not occur during the heating and resulting production of aerosol. In other instances, there may be incidental pyrolysis, with production of oxidized or other thermal decomposition byproducts at levels that are insignificant relative to the primary constituents released by heating of the plant materials.

The aerosol-forming substrate 160 may be a fibrous material. For instance, the fibrous material may be a botanical material. The fibrous material is configured to release a compound when heated. The compound may be a naturally occurring constituent of the fibrous material. For instance, the fibrous material may be plant material such as tobacco, and the compound released may be nicotine. The term “tobacco” includes any tobacco plant material including tobacco leaf, tobacco plug, reconstituted tobacco, compressed tobacco, shaped tobacco, or powder tobacco, and combinations thereof from one or more species of tobacco plants, such as Nicotiana rustica and Nicotiana tabacum.

In some example embodiments, the tobacco material may include material from any member of the genus Nicotiana. In addition, the tobacco material may include a blend of two or more different tobacco varieties. Examples of suitable types of tobacco materials that may be used include, but are not limited to, flue-cured tobacco, Burley tobacco, Dark tobacco, Maryland tobacco, Oriental tobacco, rare tobacco, specialty tobacco, blends thereof, and the like. The tobacco material may be provided in any suitable form, including, but not limited to, tobacco lamina, processed tobacco materials, such as volume expanded or puffed tobacco, processed tobacco stems, such as cut-rolled or cut-puffed stems, reconstituted tobacco materials, blends thereof, and the like. In some example embodiments, the tobacco material is in the form of a substantially dry tobacco mass. Furthermore, in some instances, the tobacco material may be mixed and/or combined with at least one of propylene glycol, glycerin, sub-combinations thereof, or combinations thereof.

The compound may also be a naturally occurring constituent of a medicinal plant that has a medically-accepted therapeutic effect. For instance, the medicinal plant may be a cannabis plant, and the compound may be a cannabinoid. Cannabinoids interact with receptors in the body to produce a wide range of effects. As a result, cannabinoids have been used for a variety of medicinal purposes (e.g., treatment of pain, nausea, epilepsy, psychiatric disorders). The fibrous material may include the leaf and/or flower material from one or more species of cannabis plants such as Cannabis sativa, Cannabis indica, and Cannabis ruderalis. In some instances, the fibrous material is a mixture of 60-80% (e.g., 70%) Cannabis sativa and 20-40% (e.g., 30%) Cannabis indica.

Examples of cannabinoids include tetrahydrocannabinolic acid (THCA), tetrahydrocannabinol (THC), cannabidiolic acid (CBDA), cannabidiol (CBD), cannabinol (CBN), cannabicyclol (CBL), cannabichromene (CBC), and cannabigerol (CBG). Tetrahydrocannabinolic acid (THCA) is a precursor of tetrahydrocannabinol (THC), while cannabidiolic acid (CBDA) is precursor of cannabidiol (CBD). Tetrahydrocannabinolic acid (THCA) and cannabidiolic acid (CBDA) may be converted to tetrahydrocannabinol (THC) and cannabidiol (CBD), respectively, via heating. In an example embodiment, heat from a heater (e.g., heating assembly 140 shown in FIG. 3) may cause decarboxylation so as to convert the tetrahydrocannabinolic acid (THCA) in the capsule 100 to tetrahydrocannabinol (THC), and/or to convert the cannabidiolic acid (CBDA) in the capsule 100 to cannabidiol (CBD).

In instances where both tetrahydrocannabinolic acid (THCA) and tetrahydrocannabinol (THC) are present in the capsule 100, the decarboxylation and resulting conversion will cause a decrease in tetrahydrocannabinolic acid (THCA) and an increase in tetrahydrocannabinol (THC). At least 50% (e.g., at least 87%) of the tetrahydrocannabinolic acid (THCA) may be converted to tetrahydrocannabinol (THC) during the heating of the capsule 100. Similarly, in instances where both cannabidiolic acid (CBDA) and cannabidiol (CBD) are present in the capsule 100, the decarboxylation and resulting conversion will cause a decrease in cannabidiolic acid (CBDA) and an increase in cannabidiol (CBD). At least 50% (e.g., at least 87%) of the cannabidiolic acid (CBDA) may be converted to cannabidiol (CBD) during the heating of the capsule 100.

Furthermore, the compound may be or may additionally include a non-naturally occurring additive that is subsequently introduced into the fibrous material. In one instance, the fibrous material may include at least one of cotton, polyethylene, polyester, rayon, combinations thereof, or the like (e.g., in a form of a gauze). In another instance, the fibrous material may be a cellulose material (e.g., non-tobacco and/or non-cannabis material). In either instance, the compound introduced may include nicotine, cannabinoids, and/or flavorants. The flavorants may be from natural sources, such as plant extracts (e.g., tobacco extract, cannabis extract), and/or artificial sources. In yet another instance, when the fibrous material includes tobacco and/or cannabis, the compound may be or may additionally include one or more flavorants (e.g., menthol, mint, vanilla). Thus, the compound within the aerosol-forming substrate 160 may include naturally occurring constituents and/or non-naturally occurring additives. In this regard, it should be understood that existing levels of the naturally occurring constituents of the aerosol-forming substrate 160 may be increased through supplementation. For example, the existing levels of nicotine in a quantity of tobacco may be increased through supplementation with an extract containing nicotine. Similarly, the existing levels of one or more cannabinoids in a quantity of cannabis may be increased through supplementation with an extract containing such cannabinoids.

FIG. 4 is a cross-sectional view of the capsule 100 of FIG. 1 in a first orientation within an aerosol-generating device 1000. The aerosol-generating device 1000 (e.g., a heat-not-burn aerosol-generating device) includes a mouthpiece 1015 and a device body 1025. The mouthpiece 1015 may be replaceable. In some example embodiments, an exterior of the device body 1025 may be formed from a metal (such as aluminum, stainless steel, and the like); an aesthetic, food contact rated plastic (such as, a polycarbonate (PC), acrylonitrile butadiene styrene (ABS) material, liquid crystalline polymer (LCP), a copolyester plastic, or any other suitable polymer and/or plastic); or any combination thereof. The mouthpiece 1015 may be similarly formed from a metal (such as aluminum, stainless steel, and the like); an aesthetic, food contact rated plastic (such as, a polycarbonate (PC), acrylonitrile butadiene styrene (ABS) material, liquid crystalline polymer (LCP), a copolyester plastic, or any other suitable polymer and/or plastic); and/or plant-based materials (such as wood, bamboo, and the like). One or more interior surfaces or the device body 1025 may be formed from or coated with a high temperature plastic (such as, polyetheretherketone (PEEK), liquid crystal polymer (LCP), or the like).

A power source 1035 and control circuitry 1045 are disposed within the device body 1025 of the aerosol-generating device 1000. The control circuitry 1045 may be hardware including logic circuits; a hardware/software combination such as a processor executing software; or a combination thereof. For example, the control circuitry 1045 may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The supply of current from the power source 1035 may be in response to a manual operation (e.g., button-activation) or an automatic operation (e.g., puff-activation). The power source 1035 may include one or more batteries (e.g., rechargeable dual battery arrangement, lithium-ion battery, and/or fuel cells). In at least some example embodiments, the control circuitry 1045 may further include a haptic motor that may be disposed on a side of the power source 1035.

The aerosol-generating device 1000 is configured to receive the capsule 100, which may be as described in connection with any of the embodiments herein. The aerosol-generating device 1000 also includes an engagement assembly configured to electrically contact the capsule 100. In an example embodiment, the engagement assembly includes a first electrode 1055a and a second electrode 1055b, each configured to electrically contact one of the first outer electrical contact 142a, the second outer electrical contact 142b, or the inner electrical contact 146 of the heating assembly 140 of the capsule 100.

For example, FIG. 4 illustrates the capsule 100 in a first orientation in which the first electrode 1055a electrically contacts the first outer electrical contact 142a of the heating assembly 140, and the second electrode 1055b electrically contacts the inner electrical contact 146. In this arrangement, the power source 1035 provides current to heat the first heater section 144a of the heating assembly 140, when activated, thereby generating an aerosol from the aerosol-forming substrate 160 that is contained and consequently heated in the first internal compartment 132a of the capsule 100. Activation may occur automatically (e.g., via puff detection) when a negative pressure is applied to the mouthpiece 1015 of the aerosol-generating device 1000. In response to the negative pressure, ambient air is drawn into the device body 1025 via an air inlet 1065 and directed to the capsule 100 where the air enters the first internal compartment 132a of the capsule 100 via the first inlet opening 122a. The air then flows through the aerosol-forming substrate 160 and entrains the volatiles released therefrom such that the generated aerosol leaves the first internal compartment 132a via the first outlet opening 112a prior to exiting the aerosol-generating device 1000 through the mouthpiece 1015.

FIG. 5 is a cross-sectional view of the capsule 100 of FIG. 1 in a second orientation within the aerosol-generating device 1000. In the second orientation illustrated in FIG. 5, the first electrode 1055a is in electrical contact with the second outer electrical contact 142b of the heating assembly 140, and the second electrode 1055b electrically contacts the inner electrical contact 146. In this second orientation, the power source 1035 provides current to heat the second heater section 144b of the heating assembly 140, when activated, thereby generating an aerosol from the aerosol-forming substrate 160 that is contained and consequently heated in the second internal compartment 132b of the capsule 100. As noted supra, activation may occur automatically (e.g., via puff detection) when a negative pressure is applied to the mouthpiece 1015 of the aerosol-generating device 1000. In response to the negative pressure, ambient air is drawn into the device body 1025 via an air inlet 1065 and directed to the capsule 100 where the air enters the second internal compartment 132b of the capsule 100 via the second inlet opening 122b. The air then flows through the aerosol-forming substrate 160 and entrains the volatiles released therefrom such that the generated aerosol leaves the second internal compartment 132b via the second outlet opening 112b prior to exiting the aerosol-generating device 1000 through the mouthpiece 1015. Although the air inlet 1065 is shown in FIGS. 4-5 as being in the upstream end (e.g., bottom) of the device body 1025, it should be understood that other configurations are possible. For example, in some instances, the air inlet 1065 may be defined in a sidewall of the device body 1025. In other instances, the air inlet 1065 may even be defined in a downstream end of the device body 1025 (e.g., adjacent to a top edge).

In the example embodiments illustrated in FIGS. 4 and 5, an adult operator may insert the capsule 100 into the device body 1025 of the aerosol-generating device 1000, in the first orientation, to generate aerosols using the aerosol-forming substrate 160 contained in the first internal compartment 132a of the capsule 100. For example, in the first orientation illustrated in FIG. 4, the mouthpiece 1015 is aligned with the first inlet opening 122a and the first outlet opening 112a, in order to facilitate a draw of the aerosols generated by heating the aerosol-forming substrate 160 contained in the first internal compartment 132a when current is supplied from the power source 1035 to the first heater section 144a (e.g., via the first electrode 1055a in contact with the first outer electrical contact 142a, and the second electrode 1055b in contact with the inner electrical contact 146).

After a desired time period (e.g., after a portion or all of the aerosol-forming substrate 160 in the first internal compartment 132a is consumed or depleted), the adult operator may remove the capsule 100 from the device body 1025 of the aerosol-generating device 1000, and re-insert the capsule 100 into the device body 1025 in the second orientation illustrated in FIG. 5. For example, the capsule 100 may be rotated approximately 180 degrees, flipped horizontally, etc., such that the mouthpiece 1015 is aligned with the second inlet opening 122b, the second internal compartment 132b, and the second outlet opening 112b. This allows the adult operator to have a more direct path to receive aerosols generated by the aerosol-forming substrate 160 located in the second internal compartment 132b, when current is supplied from the power source 1035 to the second heater section 144b (e.g., via the first electrode 1055a in contact with the second outer electrical contact 142b, and the second electrode 1055b in contact with the inner electrical contact 146).

As shown in FIGS. 4 and 5, in some example embodiments the aerosol-generating device 1000 only uses two electrical contacts (e.g., the first electrode 1055a and the second electrode 1055b) to supply a current to the capsule 100. When the capsule 100 is inserted into the device body 1025 in the first orientation shown in FIG. 4, the first outer electrical contact 142a and the inner electrical contact 146 are connected to the first electrode 1055a and the second electrode 1055b, respectively. Upon completion of heating the aerosol-forming substrate 160 (e.g., once a majority of the desired compounds in the aerosol-forming substrate 160 have been volatilized or otherwise depleted), the capsule 100 may be ejected from the device body 1025, flipped over, and reinserted into the device body 1025 in the second orientation shown in FIG. 5. In the second orientation, the second outer electrical contact 142b and the inner electrical contact 146 are connected to the first electrode 1055a and the second electrode 1055b, respectively.

Although example embodiments herein have been discussed with the first electrode 1055a and the second electrode 1055b being stationary or fixed within the device body 1025, it should be understood that, in some instances, the first electrode 1055a and the second electrode 1055b may be configured to be mobile or movable. For instance, the first electrode 1055a and the second electrode 1055b may be configured to be slidable (e.g., mounted on a slidable carriage that is engaged to a track) so as to be able to transition between a first position (e.g., to activate the first heater section 144a) and a second position (e.g., to activate the second heater section 144b). In such an instance, the first electrode 1055a and the second electrode 1055b may be manually maneuvered to slide via an externally-accessible actuator (e.g., bistable toggle knob). As a result, in instances where the first electrode 1055a and the second electrode 1055b are mobile, it may be unnecessary to remove and flip the capsule 100 in order to heat another desired internal compartment of the capsule 100. Regardless of a stationary configuration or a mobile configuration, two device-side electrical contacts (e.g., first electrode 1055a and the second electrode 1055b) and three capsule-side electrical contacts (e.g., first outer electrical contact 142a, inner electrical contact 146, second outer electrical contact 142b) may be utilized to generate aerosol from a plurality of discrete quantities of aerosol-forming substrate 160 within a capsule 100.

Although FIGS. 4 and 5 illustrate the aerosol-generating device 1000 as including two electrodes (e.g., the first electrode 1055a and the second electrode 1055b), other example embodiments may include more than two electrodes. For example, the aerosol-generating device 1000 may include three electrodes, each connected to a different one of the first outer electrical contact 142a, the second outer electrical contact 142b, and the inner electrical contact 146. The control circuitry 1045 may selectively heat one of the first heater section 144a and the second heater section 144b by controlling which electrodes supply power to the first outer electrical contact 142a, the second outer electrical contact 142b, and the inner electrical contact 146, or may heat both the first heater section 144a and the second heater section 144b at the same time. In some example embodiments, the control circuitry 1045 may be configured to sequentially heat the first heater section 144a and the second heater section 144b, by selectively applying current to the contacts corresponding to each heater section, or by supplying current to the first electrode 1055a and the second electrode 1055b when the capsule 100 is in the first orientation of FIG. 4 and then again when the capsule 100 is in the second orientation of FIG. 5. In some example embodiments, the control circuitry 1045 may heat one of the first heater section 144a and the second heater section 144b based on operator input or control. For example, an adult operator may provide input to select which of the first heater section 144a and/or the second heater section 144b to heat using the control circuitry 1045, or the control circuitry 1045 may heat the first heater section 144a or the second heater section 144b by default and allow the adult operator to change heater sections via input. In some example embodiments, the control circuitry 1045 may automatically detect which heater section to heat, such as by detecting whether there is any aerosol-forming substrate 160 remaining in either the first internal compartment 132a, the second internal compartment 132b, or both compartments. The control circuitry 1045 may determine that aerosol-forming substrate 160 in the first compartment 132a was previously aerosolized, and then proceed to heating the second heater section 144b in the second internal compartment 132b (or vice versa).

As described above, when the capsule 100 is inserted into the aerosol-generating device 1000, the control circuitry 1045 may instruct the power source 1035 to supply an electric current to the first electrode 1055a and the second electrode 1055b of the engagement assembly. The supply of current from the power source 1035 may be in response to a manual operation (e.g., button-activation) or an automatic operation (e.g., puff-activation). As a result of the current, the capsule 100 may be heated to generate an aerosol. For example, the aerosol-forming substrate 160 in the first internal compartment 132a may generate the aerosol in the first orientation illustrated in FIG. 4, and the aerosol-forming substrate 160 in the second internal compartment 132b may generate the aerosol in the second orientation illustrated in FIG. 5. The aerosol generated may be drawn from the aerosol-generating device 1000 via the mouthpiece 1015.

Further to the non-limiting embodiments set forth herein, additional details of the substrates, capsules, devices, and methods discussed herein may also be found in U.S. application Ser. No. 17/981,973, filed Nov. 7, 2022, titled “CAPSULES HAVING ELECTRICAL CONTACT PADS WITH SURFACE DISCONTINUITIES AND HEAT-NOT-BURN (HNB) AEROSOL-GENERATING DEVICES INCLUDING THE SAME,” Atty. Dkt. No. 24000NV-000874-US; U.S. application Ser. No. 16/451,662, filed Jun. 25, 2019, titled “CAPSULES, HEAT-NOT-BURN (HNB) AEROSOL-GENERATING DEVICES, AND METHODS OF GENERATING AN AEROSOL,” Atty. Dkt. No. 24000NV-000522-US; U.S. application Ser. No. 16/252,951, filed Jan. 21, 2019, titled “CAPSULES, HEAT-NOT-BURN (HNB) AEROSOL-GENERATING DEVICES, AND METHODS OF GENERATING AN AEROSOL,” Atty. Dkt. No. 24000NV-000521-US; U.S. application Ser. No. 15/845,501, filed Dec. 18, 2017, titled “VAPORIZING DEVICES AND METHODS FOR DELIVERING A COMPOUND USING THE SAME,” Atty. Dkt. No. 24000DM-000012-US; and U.S. application Ser. No. 15/559,308, filed Sep. 18, 2017, titled “VAPORIZER FOR VAPORIZING AN ACTIVE INGREDIENT,” Atty. Dkt. No. 24000DM-000003-US-NP, the disclosures of each of which are incorporated herein in their entirety by reference.

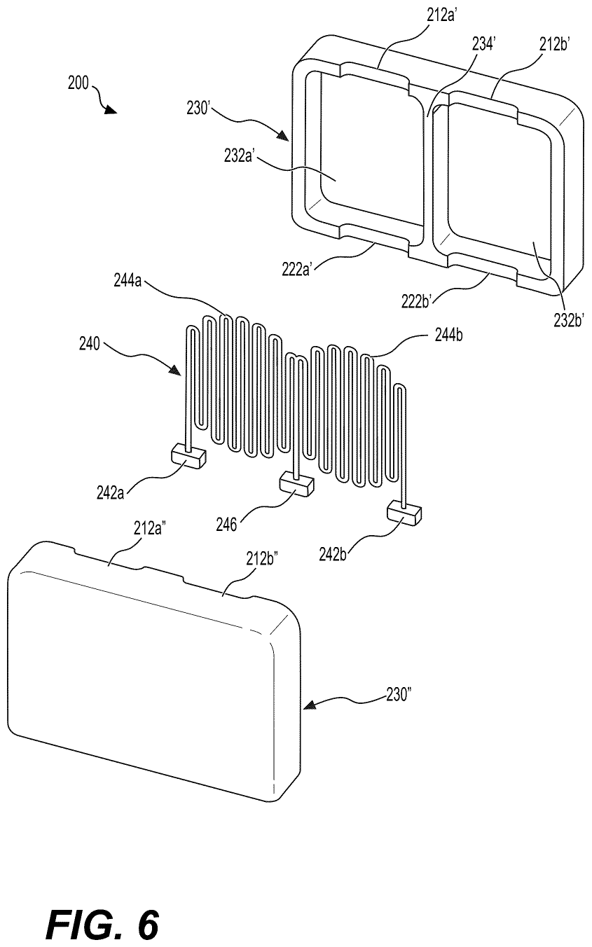

FIG. 6 is an exploded view of a capsule 200 for an aerosol-generating device according to an example embodiment. The capsule 200, when assembled, may be similar to the capsule 100 illustrated in FIG. 1. Thus, the description of the features in common which have already been discussed above should be understood to also apply to this section and may not have been repeated in the interest of brevity. As shown in FIG. 6, the capsule 200 includes a first housing section 230′ and a second housing section 230″. The first housing section 230′ and the second housing section 230″ may have the same or substantially the same shape, size, and cross-sectional profile, to align with and complement one another. As a result, in instances where the first housing section 230′ and the second housing section 230″ mirror each other, one housing section can serve as either the first housing section 230′ or the second housing section 230″, which can simplify manufacturing and assembly. The first housing section 230′ defines a first recess 232a′ and a second recess 232b′. Similarly, although not illustrated in FIG. 6, the second housing section 230″ also defines recesses identical or complementary to the first recess 232a′ and the second recess 232b′ of the first housing section 230′. When assembled, the combination of the first recess 232a′ of the first housing section 230′ and the corresponding recess of the second housing section 230″ will result in an internal compartment similar to the first internal compartment 132a of the capsule 100 of FIG. 1. Likewise, the combination of the second recess 232b′ of the first housing section 230′ and the corresponding recess of the second housing section 230″ will result in an internal compartment similar to the second internal compartment 132b of the capsule 100 of FIG. 1.

The first housing section 230′ of the capsule 200 includes a partition 234′ which separates the first recess 232a′ and the second recess 232b′. Similarly, although not illustrated in FIG. 6, the second housing section 230″ also includes a partition that is identical or complementary to the partition 234′ of the first housing section 230′. When assembled, the combination of the partition 234′ of the first housing section 230′ and the corresponding partition of the second housing section 230″ will result in a partition wall which may be similar to the partition wall 134 of the capsule 100 of FIG. 1. The arrangement of the first housing section 230′ and the second housing section 230″ may facilitate a simplified manufacturing process for the capsule 200. For example, the heating assembly 240 may be positioned between the first housing section 230′ and the second housing section 230″, and aerosol-forming substrate 160 may be placed in the first recess 232a′ and the second recess 232b′ of the first housing section 230′ as well as the corresponding recesses of the second housing section 230″, prior to joining the first housing section 230′ and the second housing section 230″. In some example embodiments, the heating assembly 240 may be sandwiched between portions of the first housing section 230′ and the second housing section 230″ that define the partitions (e.g., partition 234′), such that the heating assembly 240 is embedded in the resulting partition wall of the capsule 200. Likewise, the first outer electrical contact 242a, the second outer electrical contact 242b, and the inner electrical contact 246 may be embedded while having exposed portions as the electrical contact surfaces (e.g., such as shown in connection with capsule 100 in FIG. 2).

The heating assembly 240 may include a first heater section 244a and a second heater section 244b. The first heater section 244a is located in the first internal compartment formed by the first recess 232a′ of the first housing section 230′ and the corresponding recess of the second housing section 230″ when the first housing section 230′ is coupled with the second housing section 230″. Similarly, the second heater section 244b is located in the second internal compartment formed by the second recess 232b′ of the first housing section 230′ and the corresponding recess of the second housing section 230″ when the first housing section 230′ is coupled with the second housing section 230″. The heating assembly 240 may be similar to the heating assembly 140 of the capsule 100 in FIG. 1.

As shown in FIG. 6, a first outer electrical contact 242a is at a first outer end or terminus of the heating assembly 240 and is configured to transmit a current to the first heater section 244a. Conversely, a second outer electrical contact 242b is at a second outer end or terminus of the heating assembly 240 and is configured to transmit a current to the second heater section 244b. An inner electrical contact 246 is located between the first outer electrical contact 242a and the second outer electrical contact 242b. The inner electrical contact 246 is configured to transmit a current to the first heater section 244a and/or the second heater section 244b.

When the first housing section 230′ is in contact with (e.g., attached to) the second housing section 230″, each of the first outer electrical contact 242a, the second outer electrical contact 242b, and the inner electrical contact 246 may include at least a portion that is even with (e.g., flush) or extends beyond a bottom surface (e.g., upstream surface) of the first housing section 230′ and the second housing section 230″, in order to make electrical contact with a power source (such as via the first electrode 1055a and the second electrode 1055b illustrated in FIGS. 4 and 5). In some embodiments, at least a portion of each of the first outer electrical contact 242a, the second outer electrical contact 242b, and the inner electrical contact 246 may be embedded in the first housing section 230′ and/or the second housing section 230″, or sandwiched between the first housing section 230′ and the second housing section 230″, when the first housing section 230′ is in contact with the second housing section 230″.

The first housing section 230′ defines a first outlet groove 212a′, and the second housing section 230″ defines a corresponding third outlet groove 212a″. When the first housing section 230′ is in contact with the second housing section 230″, the first outlet groove 212a′ and the corresponding third outlet groove 212a″ may define a first outlet opening. For example, the first outlet opening defined by the first outlet groove 212a′ and the third outlet groove 212a″ may be similar to the first outlet opening 112a of the capsule 100 of FIG. 1.

Similarly, the first housing section 230′ defines a second outlet groove 212b′, and the second housing section 230″ defines a corresponding fourth outlet groove 212b″. When the first housing section 230′ is in contact with the second housing section 230″, the second outlet groove 212b′ and the corresponding fourth outlet groove 212b″ may define a second outlet opening. For example, the second outlet opening defined by the second outlet groove 212b′ and the fourth outlet groove 212b″ may be similar to the second outlet opening 112b of the capsule 100 of FIG. 1.

At a lower end (e.g., upstream end) of the capsule 200, the first housing section 230′ defines a first inlet groove 222a′ and a second inlet groove 222b′. Similarly, although not shown in FIG. 6, the second housing section 230″ defines a third inlet groove and a fourth inlet groove which correspond to the first inlet groove 222a′ and the second inlet groove 222b′, respectively, of the first housing section 230′. When the first housing section 230′ is in contact with the second housing section 230″, the first inlet groove 222a′ may contribute to defining a first inlet opening (e.g., in conjunction with a corresponding third inlet groove of the second housing section 230″ which is not shown in FIG. 6). For example, the first inlet opening defined by the first inlet groove 222a′ and corresponding third inlet groove may be similar to the first inlet opening 122a of the capsule 100 of FIG. 2. Additionally, the second inlet groove 222b′ may contribute to defining a second inlet opening (e.g., in conjunction with a corresponding fourth inlet groove on the second housing section 230″ which is not shown in FIG. 6). For example, the second inlet opening defined by the second inlet groove 222b′ and corresponding fourth inlet groove may be similar to the second inlet opening 122b of the capsule 100 of FIG. 2.

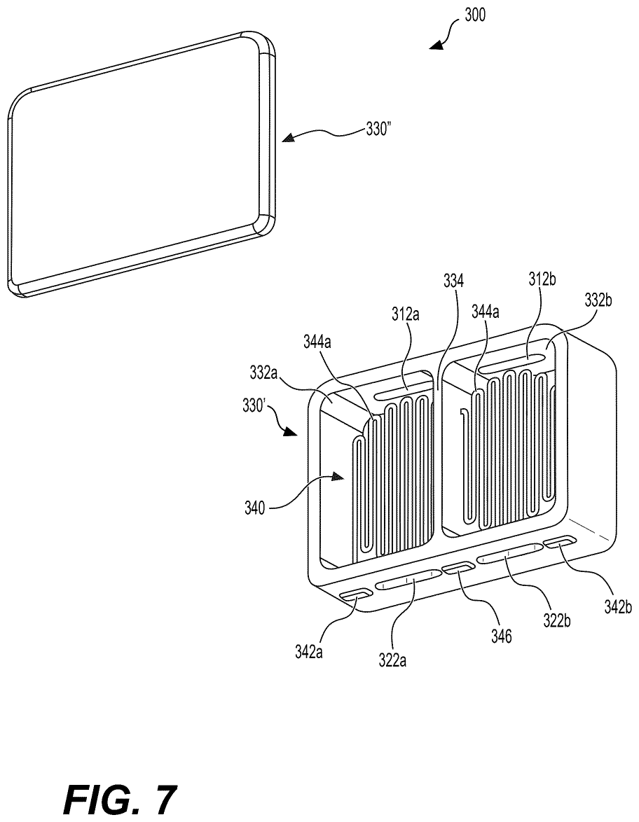

FIG. 7 is a partially exploded view of another capsule 300 for an aerosol-generating device according to an example embodiment. The capsule 300, when assembled, may be similar to the capsule 100 illustrated in FIG. 1 and the capsule 200 illustrated in FIG. 6. Thus, the description of the features in common which have already been discussed above should be understood to also apply to this section and may not have been repeated in the interest of brevity. As shown in FIG. 7, the capsule 300 includes a first housing section 330′ and a second housing section 330″. The second housing section 330″ may be considered a cover, a lid, a cap, a wall, etc., which may be coupled to the first housing section 330′. For example, while the capsule 200 in FIG. 6 includes a first housing section 230′ and a second housing section 230″ that are substantially similar to one another and divide the capsule 200 approximately in half, the first housing section 330′ of the capsule 300 may define most or all of the side walls of the first internal compartment 332a, the second internal compartment 332b, and the partition wall 334, while the second housing section 330″ acts as a cover to define a front wall (or a back wall) of each of the first internal compartment 332a and the second internal compartment 332b.

As shown in FIG. 7, the heating assembly 340 is located within the first housing section 330′. For example, the heating assembly 340 may be embedded in the partition wall 334 of the first housing section 330′ (e.g., during manufacturing of the first housing section 330′), rather than sandwiched between the first housing section 230′ and the second housing section 230″ of the capsule 200 as shown in FIG. 6.

The heating assembly 340 of FIG. 7 includes a first heater section 344a located in the first internal compartment 332a, and a second heater section 334b located in the second internal compartment 332b. The arrangement of the capsule 300 may facilitate simplified insertion of the aerosol-forming substrate 160 into the first internal compartment 332a and the second internal compartment 332b (e.g., such as during manufacture of the capsule 300). For example, the aerosol-forming substrate 160 may be placed in the first internal compartment 332a and the second internal compartment 332b while the second housing section 330″ is separate from the first housing section 330′, and the second housing section 330″ may then be coupled with the first housing section 330′ to retain the aerosol-forming substrate 160 in the capsule 300. Alternatively, although not illustrated, the housing of the capsule 300 may be manufactured such that an edge of the second housing section 330″ is connected to a corresponding edge of the first housing section 330′ in a flexible, hinge-like arrangement such that the second housing section 330″ can be flipped to close off the first internal compartment 332a and the second internal compartment 332b and then sealed or otherwise secured to enclose the aerosol-forming substrate 160 after loading.

As shown in FIG. 7, a first outer electrical contact 342a is at a first outer end or terminus of the heating assembly 340 and is configured to transmit a current to the first heater section 344a. Conversely, a second outer electrical contact 342b is at a second outer end or terminus of the heating assembly 340 and is configured to transmit a current to the second heater section 344b. An inner electrical contact 346 is located between the first outer electrical contact 342a and the second outer electrical contact 342b. The inner electrical contact 346 is configured to transmit a current to the first heater section 344a and/or the second heater section 344b.

Each of the first outer electrical contact 342a, the second outer electrical contact 342b, and the inner electrical contact 346 may include at least a portion that is even with (e.g., flush) or extends beyond a bottom surface (e.g., upstream surface) of the first housing section 330′, in order to make electrical contact with a power source (such as via the first electrode 1055a and the second electrode 1055b illustrated in FIGS. 4 and 5). In some embodiments, at least a portion of each of the first outer electrical contact 342a, the second outer electrical contact 342b, and the inner electrical contact 346 may be embedded in the first housing section 330′.

The first housing section 330′ defines a first inlet opening 322a, a second inlet opening 322b, a first outlet opening 312a, and a second outlet opening 312b. For example, the first inlet opening 322a may be similar to the first inlet opening 122a of the capsule 100 in FIGS. 1-2, the second inlet opening 322b may be similar to the second inlet opening 122b, the first outlet opening 312a may be similar to the first outlet opening 112a, and the second outlet opening 312b may be similar to the second outlet opening 112b.

FIG. 8 is a partially exploded view of another capsule 400 for an aerosol-generating device according to an example embodiment. The capsule 400, when assembled, may be similar to the capsule 100 illustrated in FIG. 1, the capsule 200 illustrated in FIG. 6, and the capsule 300 illustrated in FIG. 7. Thus, the description of the features in common which have already been discussed above should be understood to also apply to this section and may not have been repeated in the interest of brevity. As shown in FIG. 8, the capsule 400 includes a first housing section 430′ and a second housing section 430″. The second housing section 430″ may be considered a cover, a lid, a cap, a top wall, etc., which may be coupled to the first housing section 430′. For example, while the capsule 200 in FIG. 6 includes a first housing section 230′ and a second housing section 230″ that are substantially similar to one another and divide the capsule 200 approximately in half, the first housing section 430′ of the capsule 400 may define most or all of the bottom and side walls of the first internal compartment 432a, the second internal compartment 432b, and the partition wall 434, while the second housing section 430″ acts as a lid to define one top wall (or downstream wall) of each of the first internal compartment 432a and the second internal compartment 432b.

As shown in FIG. 8, the heating assembly 440 is located within the first housing section 430′. For example, the heating assembly 440 may be embedded in the partition wall 434 of the first housing section 430′ (e.g., during manufacturing of the first housing section 430′), rather than sandwiched between the first housing section 430′ and the second housing section 430″ of the capsule 200 as shown in FIG. 6.

The heating assembly 440 of FIG. 8 includes a first heater section 444a located in the first internal compartment 432a, and a second heater section 444b located in the second internal compartment 432b. The arrangement of the capsule 400 may facilitate simplified insertion of the aerosol-forming substrate 160 into the first internal compartment 432a and the second internal compartment 432b (e.g., such as during manufacture of the capsule 400). For example, the aerosol-forming substrate 160 may be placed in the first internal compartment 432a and the second internal compartment 432b while the second housing section 430″ is separate from the first housing section 430′, and the second housing section 430″ may then be coupled with the first housing section 430′ to retain the aerosol-forming substrate 160 in the capsule 400. Alternatively, although not illustrated, the housing of the capsule 400 may be manufactured such that an edge of the second housing section 430″ is connected to a corresponding edge of the first housing section 430′ in a flexible, hinge-like arrangement such that the second housing section 430″ can be flipped to close off the first internal compartment 432a and the second internal compartment 432b and then sealed or otherwise secured to enclose the aerosol-forming substrate 160 after loading.

As shown in FIG. 8, the second housing section 430″ defines a first outlet opening 412a and a second outlet opening 412b. For example, the first outlet opening 412a may be similar to the first outlet opening 112a of the capsule 100 in FIG. 1, and the second outlet opening 412b may be similar to the second outlet opening 112b.

In some example embodiments, an aerosol-generating device may include a capsule and a device body configured to receive the capsule. The capsule defines a plurality of internal compartments containing an aerosol-forming substrate and including a heating assembly extending into each of the plurality of internal compartments. The device body is configured to supply an electric current to sections of the heating assembly so as to sequentially (or, if desired, simultaneously) heat the aerosol-forming substrate within the plurality of internal compartments of the capsule to generate an aerosol. For example, the plurality of internal compartments may include aerosol-forming substrate materials having different nicotine amounts, different active ingredient amounts, etc., which may be heated sequentially or simultaneously. In some example embodiments, an internal compartment may include an aerosol-forming substrate material having nicotine or an active ingredient, while another internal compartment includes a flavorant (which may or may not include tobacco or an active ingredient), and each compartment may be heated sequentially or simultaneously.

The plurality of internal compartments may include a first compartment and a second compartment. The aerosol-forming substrate may include a first substrate in the first compartment and a second substrate in the second compartment. The device body may be configured to selectively heat the first substrate when the capsule is in a first orientation within the device body and configured to selectively heat the second substrate when the capsule is in a second orientation within the device body.

In some example embodiments, a method of using an aerosol-generating device includes receiving a capsule into a device body of the aerosol-generating device in a first orientation, and supplying current to a first heater section of a heating assembly of the capsule to heat an aerosol-forming substrate located in a first internal compartment of the capsule. The method additionally includes removing the capsule from the device body, receiving the capsule into the device body in a second orientation, and supplying current to a second heater section of the heating assembly to heat an aerosol-forming substrate located in a second internal compartment of the capsule.

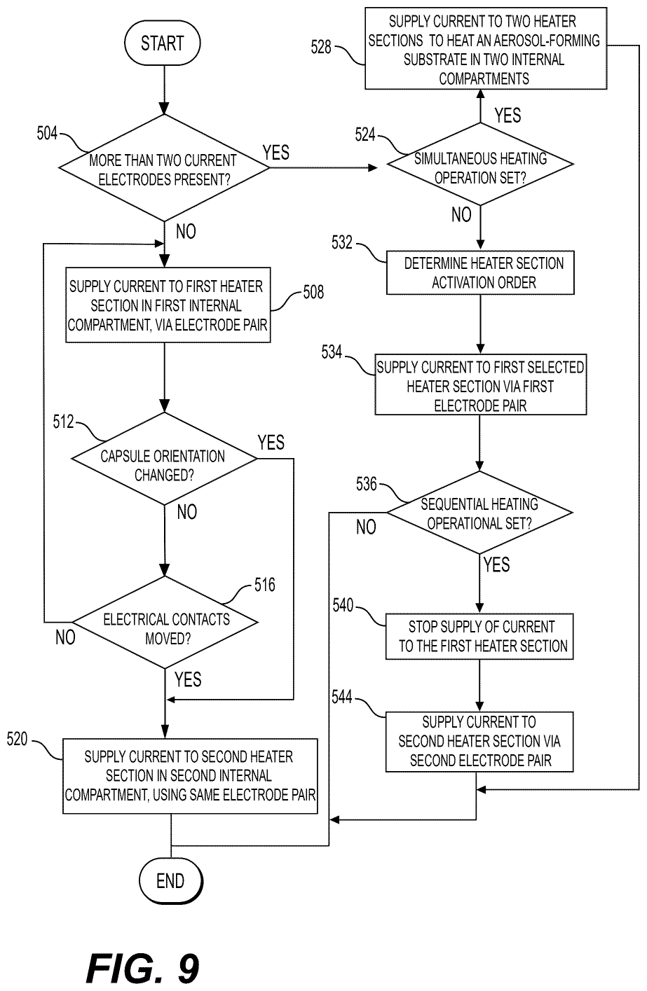

FIG. 9 is a flowchart depicting an example method/process of heating a capsule according to an example embodiment. At 504, the process begins by determining whether the device body includes more than two electrodes for supplying current to heater sections of a capsule. If not, control circuitry of the device body supplies current to a first heater section at 508. For example, a first heater section of a heating assembly may be located in a first internal compartment of a capsule, and the control circuitry may supply current to the first heater section via a first electrode pair to heat an aerosol-forming substrate located in the first internal compartment.

At 512, the process determines whether a capsule orientation has changed. For example, the capsule may be received in the device body in a first orientation where the first heater section contacts electrodes of the device body. After heating the aerosol-forming substrate located in the first internal compartment while the capsule is in the first orientation, an adult operator may remove the capsule and then reinsert the capsule into the device body in a second orientation where a second heater section is in contact with the electrodes of the device body. If the capsule changes orientation at 512, the process supplies current from the control circuitry to the second heater section using the same electrode pair to heat an aerosol-forming substrate in the second internal compartment.

If the capsule has not changed orientation at 512, the process continues to 516 to determine whether electrical contacts of the device body (e.g., the electrode pair) have moved. For example, the device body may be configured to allow an adult operator to manually slide the electrical contacts from a first position, where the electrode pair is in contact with the first heater section, to a second position where the electrode pair is in contact with the second heater section. If the electrical contacts have moved at 512, the control circuitry is configured to supply current to the second heater section using the same electrode pair (e.g., in the second electrical contact position) to heat an aerosol-forming substrate in the second internal compartment.

Returning again to 504, if the device body includes more than two electrodes, the process proceeds to 524 to determine whether a simultaneous heating operation has been set. For example, the device body may include three (or more) electrodes, which are arranged to contact multiple heater sections of the capsule using different electrode pairs. The device body may be configured to receive user input for selection of heating multiple compartments of the capsule at the same time. If a simultaneous heating operation has been set at 524, the control circuitry is configured to supply current to two heater sections simultaneously (e.g., via three electrodes arranged in two electrode pairs that each contact different heater sections of a heating assembly). This may simultaneously heat an aerosol-forming substrate in each of the multiple internal compartments. Simultaneous heating may include at least partial simultaneous heating, where current is supplied to two heater sections during a time period, but a start and stop of current to each heater section may not begin and end at the same time.

If a simultaneous heating operation is not set at 524, the process determines a heater section activation order at 532. For example, the device body may have a default or predetermined order set, such as starting heating at a first pair of electrodes, and subsequently heating a second pair of electrodes. An adult operator may be allowed to switch the change the order of heating if desired, such that current is supplied to pairs of electrodes in a different order. At 534, control circuitry supplies current to the first selected heater section, via a first electrode pair (e.g., the selected pair of electrodes which is in contract with the first selected heater section). At 536, the process determines whether a sequential heating operation has been set. If so, the control circuitry stops supplying current to the first heater section at 540, and then supplies current to the second heater section via a second electrode pair at 544.

In some example embodiments, a capsule may be manufactured using injection molding for two housing sections (such as two halves of the housing of the capsule), by stamping or forming a metal shell and attaching it to an over-molded heater subassembly, etc. For example, if two halves are formed, internal compartments of each half of the housing may be filled with aerosol-generating substrate, a heater may be set on one of the halves of the housing, and the two halves of the housing may be attached to one another using any suitable manufacturing process. If a shell is stamped and formed around a heater assembly, the shell may be filled with the aerosol-forming substrate and then the over-molded heater subassembly may be inserted to form the capsule. Example capsule architectures described herein may allow for a capsule to produce two separate sessions with one heater, for a given plant material or other suitable aerosol-generating substrate. For example, sequential activation of the individually controlled heating elements may provide a multi-session inhalation experience from a single consumable.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

Illustrative Embodiment 1. A capsule for an aerosol-generating device, comprising: a housing defining a plurality of internal compartments, a plurality of inlet openings, and a plurality of outlet openings, each of the plurality of internal compartments containing an aerosol-forming substrate; and a heating assembly within the housing and extending into each of the plurality of internal compartments, the heating assembly including a plurality of heater sections and electrical contacts for the plurality of heater sections.

Illustrative Embodiment 2. The capsule of illustrative embodiment 1, wherein the housing defines a hollow polyhedron with external quadrilateral faces.

Illustrative Embodiment 3. The capsule of illustrative embodiment 1, wherein the housing includes a front face, a rear face opposite the front face, a first side face between the front face and the rear face, a second side face opposite the first side face, an upstream end face, and a downstream end face opposite the upstream end face.

Illustrative Embodiment 4. The capsule of illustrative embodiment 3, wherein the upstream end face defines the plurality of inlet openings.

Illustrative Embodiment 5. The capsule of illustrative embodiment 3, wherein the downstream end face defines the plurality of outlet openings.

Illustrative Embodiment 6. The capsule of illustrative embodiment 1, wherein the plurality of internal compartments are isolated from each other within the housing.

Illustrative Embodiment 7. The illustrative embodiment of illustrative embodiment 1, wherein the plurality of internal compartments each define a same shape and size.

Illustrative Embodiment 8. The capsule of illustrative embodiment 1, wherein each of the plurality of internal compartments is between at least one of the plurality of inlet openings and at least one of the plurality of outlet openings.

Illustrative Embodiment 9. The capsule of illustrative embodiment 1, wherein the plurality of inlet openings and the plurality of outlet openings are configured to provide an independent air flow through each of the plurality of internal compartments.

Illustrative Embodiment 10. The capsule of illustrative embodiment 1, wherein the heating assembly is embedded within the housing.

Illustrative Embodiment 11. The capsule of illustrative embodiment 1, wherein each of the plurality of heater sections is within one of the plurality of internal compartments.

Illustrative Embodiment 12. The capsule of illustrative embodiment 1, wherein the housing includes a partition wall configured to separate adjacent compartments of the plurality of internal compartments.

Illustrative Embodiment 13. The capsule of illustrative embodiment 12, wherein the heating assembly extends through the partition wall.

Illustrative Embodiment 14. The capsule of illustrative embodiment 12, wherein the plurality of heater sections includes a first heater section and a second heater section, the first heater section on one side of the partition wall, and the second heater section on an opposite side of the partition wall.

Illustrative Embodiment 15. The capsule of illustrative embodiment 14, wherein the first heater section is coplanar with the second heater section.

Illustrative Embodiment 16. The capsule of illustrative embodiment 14, wherein the electrical contacts include a first contact, a second contact, and a third contact, the first contact and the second contact configured to electrically connect the first heater section to a power source, and the second contact and the third contact configured to electrically connect the second heater section to the power source.

Illustrative Embodiment 17. The capsule of illustrative embodiment 1, wherein the aerosol-forming substrate includes a plant material.

Illustrative Embodiment 18. The capsule of illustrative embodiment 17, wherein the plant material includes tobacco.

Illustrative Embodiment 19. The capsule of illustrative embodiment 1, wherein the aerosol-forming substrate includes a same material in each of the plurality of internal compartments.

Illustrative Embodiment 20. The illustrative embodiment of illustrative embodiment 1, wherein the aerosol-forming substrate in a first one of the plurality of internal compartments includes a different material than the aerosol-forming substrate in a second one of the plurality of internal compartments.

Illustrative Embodiment 21. An aerosol-generating device, comprising: a capsule defining a plurality of internal compartments containing an aerosol-forming substrate and including a heating assembly extending into each of the plurality of internal compartments; and

a device body configured to receive the capsule and to supply an electric current to sections of the heating assembly to heat the aerosol-forming substrate within the plurality of internal compartments of the capsule to generate an aerosol.

Illustrative Embodiment 22. The aerosol-generating device of illustrative embodiment 21, wherein the plurality of internal compartments includes a first compartment and a second compartment, the aerosol-forming substrate includes a first substrate in the first compartment and a second substrate in the second compartment, and the device body is configured to selectively heat the first substrate when the capsule is in a first orientation within the device body and configured to selectively heat the second substrate when the capsule is in a second orientation within the device body.

Illustrative Embodiment 23. The aerosol-generating device of illustrative embodiment 21, wherein the device body includes two electrical contacts configured to supply the electric current to the sections of the heating assembly.

Illustrative Embodiment 24. The aerosol-generating device of illustrative embodiment 23, wherein the two electrical contacts are configured to be moveable between a first position to activate a first one of the sections of the heating assembly and a second position to activate a second one of the sections of the heating assembly.

Illustrative Embodiment 25. The aerosol-generating device of illustrative embodiment 23, wherein: the two electrical contacts are configured to connect with a first pair of electrical contacts of the capsule when the capsule is received in the device body in a first orientation; the two electrical contacts are configured to connect with a second pair of electrical contacts of the capsule when the capsule is received in the device body in a second orientation;

the first pair of electrical contacts corresponds to a first one of the sections of the heating assembly and the second pair of electrical contacts corresponds to a second one of the sections of the heating assembly; and at least one electrical contact of the first pair of electrical contacts is not included in the second pair of electrical contacts.

Illustrative Embodiment 26. The aerosol-generating device of illustrative embodiment 21, wherein the device body includes at least three electrical contacts configured to supply the electric current to the sections of the heating assembly.

Illustrative Embodiment 27. The aerosol-generating device of illustrative embodiment 21, wherein the device body is configured to supply the electric current to the sections of the heating assembly to simultaneously heat the aerosol-forming substrate within the plurality of internal compartments of the capsule.

Illustrative Embodiment 28. The aerosol-generating device of illustrative embodiment 27, wherein the aerosol-forming substrate within a first one of the plurality of internal compartments has a different nicotine amount or a different active ingredient amount than the aerosol-forming substrate within a second one of the plurality of internal compartments.

Illustrative Embodiment 29. The aerosol-generating device of illustrative embodiment 27, wherein the aerosol-forming substrate within a first one of the plurality of internal compartments includes nicotine or an active ingredient, and the aerosol-forming substrate within a second one of the plurality of internal compartments includes a flavorant.

Illustrative Embodiment 30. The aerosol-generating device of illustrative embodiment 29, wherein the aerosol-forming substrate within the second one of the plurality of internal compartments includes tobacco or the active ingredient.

Illustrative Embodiment 31. The aerosol-generating device of illustrative embodiment 21, wherein the device body is configured to supply the electric current to a first section of the heating assembly to heat the aerosol-forming substrate within a first one of the plurality of internal compartments in response to receiving an operator input selection of the first one of the plurality of internal compartments.

Illustrative Embodiment 32. The aerosol-generating device of illustrative embodiment 21, wherein the device body is configured to: supply the electric current to a first section of the heating assembly to heat the aerosol-forming substrate within a first one of the plurality of internal compartments according to an initial default setting; and supply the electric current to a second section of the heating assembly to heat the aerosol-forming substrate within a second one of the plurality of internal compartments in response to receiving an operator input selection of the second one of the plurality of internal compartments.

Illustrative Embodiment 33. The aerosol-generating device of illustrative embodiment 21, wherein the device body is configured to supply the electric current to a second section of the heating assembly to heat the aerosol-forming substrate within a second one of the plurality of internal compartments in response to a determination that the aerosol-forming substrate was previously aerosolized by a first section of the heating assembly in a first one of the plurality of internal compartments.

Illustrative Embodiment 34. A method of heating with an aerosol-generating device, comprising: receiving a capsule into a device body of the aerosol-generating device in a first orientation, the capsule defining a plurality of internal compartments containing an aerosol-forming substrate and including a heating assembly extending into each of the plurality of internal compartments; and supplying current to a first heater section of the heating assembly of the capsule to heat the aerosol-forming substrate located in a first one of the plurality of internal compartments of the capsule.

Illustrative Embodiment 35. The method of illustrative embodiment 34, further comprising: supplying current to a second heater section of the heating assembly of the capsule while supplying current to the first heater section, to at least partially simultaneously heat the aerosol-forming substrate located in the first one of the plurality of internal compartments and the aerosol-forming substrate located in a second one of the plurality of internal compartments.

Illustrative Embodiment 36. The method of illustrative embodiment 34, further comprising: stopping supply of current to the first heater section; and subsequent to stopping supply of current to the first heater section, supplying current to a second heater section of the heating assembly to sequentially heat the aerosol-forming substrate located in a second one of the plurality of internal compartments.

Illustrative Embodiment 37. The method of illustrative embodiment 34, further comprising: receiving the capsule in the device body in a second orientation; and supplying current to a second heater section of the heating assembly of the capsule to heat the aerosol-forming substrate located in a second one of the plurality of internal compartments, wherein a same pair of electrical contacts supplies the current to the capsule in the first orientation and the second orientation.

Illustrative Embodiment 38. The method of illustrative embodiment 34, further comprising: detecting that a pair of electrical contacts of the device body has moved from a first position in contact with the first heater section to a second position in contact with a second heater section of the heating assembly; and supplying current to the second heater section to heat the aerosol-forming substrate located in a second one of the plurality of internal compartments of the capsule.

1. A capsule for an aerosol-generating device, comprising:
a housing defining a plurality of internal compartments, a plurality of inlet openings, and a plurality of outlet openings, each of the plurality of internal compartments containing an aerosol-forming substrate; and
a heating assembly within the housing and extending into each of the plurality of internal compartments, the heating assembly including a plurality of heater sections and electrical contacts for the plurality of heater sections.

2. The capsule of claim 1, wherein the housing defines a hollow polyhedron with external quadrilateral faces.

3. The capsule of claim 1, wherein the housing includes a front face, a rear face opposite the front face, a first side face between the front face and the rear face, a second side face opposite the first side face, an upstream end face, and a downstream end face opposite the upstream end face.

4. The capsule of claim 3, wherein the upstream end face defines the plurality of inlet openings.

5. The capsule of claim 3, wherein the downstream end face defines the plurality of outlet openings.

6. The capsule of claim 1, wherein the plurality of internal compartments are isolated from each other within the housing.

7. The capsule of claim 1, wherein the plurality of internal compartments each define a same shape and size.

8. The capsule of claim 1, wherein each of the plurality of internal compartments is between at least one of the plurality of inlet openings and at least one of the plurality of outlet openings.

9. The capsule of claim 1, wherein the plurality of inlet openings and the plurality of outlet openings are configured to provide an independent air flow through each of the plurality of internal compartments.

10. The capsule of claim 1, wherein the heating assembly is embedded within the housing.

11. The capsule of claim 1, wherein each of the plurality of heater sections is within one of the plurality of internal compartments.

12. The capsule of claim 1, wherein the housing includes a partition wall configured to separate adjacent compartments of the plurality of internal compartments.

13. The capsule of claim 12, wherein the heating assembly extends through the partition wall.

14. The capsule of claim 12, wherein the plurality of heater sections includes a first heater section and a second heater section, the first heater section on one side of the partition wall, and the second heater section on an opposite side of the partition wall.

15. The capsule of claim 14, wherein the first heater section is coplanar with the second heater section.

16. The capsule of claim 14, wherein the electrical contacts include a first contact, a second contact, and a third contact, the first contact and the second contact configured to electrically connect the first heater section to a power source, and the second contact and the third contact configured to electrically connect the second heater section to the power source.

17. The capsule of claim 1, wherein the aerosol-forming substrate includes a plant material.

18. The capsule of claim 17, wherein the plant material includes tobacco.

19. The capsule of claim 1, wherein the aerosol-forming substrate includes a same material in each of the plurality of internal compartments.

20. The capsule of claim 1, wherein the aerosol-forming substrate in a first one of the plurality of internal compartments includes a different material than the aerosol-forming substrate in a second one of the plurality of internal compartments.
